(19) United States
(12) Patent Application Publication
(10) Pub. No.: US 2007/0223154 A1
(43) Pub. Date: Sep. 27, 2007

(54) HIGH SIDE RESET LOGIC FOR GATE DRIVER

(76) Inventors: Christian Locatelli, Broni (Pavia) (IT); Marco Giandalia, Palermo (IT); Marco Palma, Leini' (To) (IT)

Correspondence Address: OSTROLENK FABER GERB & SOFFEN, 1180 AVENUE OF THE AMERICAS, NEW YORK, NY, 100368403, US

(21) Appl. No.: 11/687,840

(22) Filed: Mar. 19, 2007

Related U.S. Application Data
(60) Provisional application No. 60/784,158, filed on Mar. 21, 2006.

(51) Int. Cl. H02H 7/00

(52) U.S. Cl. 361/18

(57) ABSTRACT

A circuit in a gate driver circuit controlling a half bridge stage having high and low switches, the gate driver circuit having a high side driving circuit for driving the high switch and low side driving circuit for driving the low switch, the circuit ensuring turning OFF of the high side driving circuit and the high switch. The circuit including an input portion for receiving input signals for the high and low side driving circuits and a shutdown signals; and an output portion for providing SET and RESET signals to the high and low side driving circuits, wherein the high side driving circuit is turned OFF when the input signal for the high side driving circuit is inactive and when the input signal for the low side driving circuit becomes active.

### CROSS-REFERENCE TO RELATED APPLICATION

This application is based on and claims priority to U.S. Provisional Patent Application Ser. No. 60/784,158, filed on Mar. 21, 2006 and entitled NEW HIGH SIDE RESET LOGIC FOR GATE DRIVER, the entire contents of which are hereby incorporated by reference herein.

### BACKGROUND OF THE INVENTION

The present invention relates to applications having a gate driver circuit for driving a half-bridge stage and more particularly to ensuring turning OFF of a high side driving circuit of the gate driver circuit in such applications.

Occurrence of a short circuit condition in the load circuit when the gate driver circuit driving the half-bridge stages does not turn OFF the high side driving circuit of the gate driver circuit and the corresponding switch, i.e., a high side switch, of the half-bridge stage can destroy the switch. In such occurrences, it is not possible to turn OFF the high side driving circuit of the gate driver circuit using a shutdown signal when an input signal HIN to the high side driving circuit of the gate driver circuit is inactive. This condition leads to a destructive effect.

Further, a shoot through condition, caused by a missing turn OFF signal in the high side driving circuit of the gate driver, can have a similarly destructive effect. This is because the high side driving circuit of the gate driver circuit and its corresponding switch in the half-bridge stage are still turned ON even if the input signal HIN to the high side driving circuit was disabled when a low side driving circuit of the gate driver circuit and its corresponding switch of the half-bridge stage was turning ON.

### SUMMARY OF THE INVENTION

It is an object of the present invention to provide a circuit that avoids the destructive effects created in the half-bridge gate driver circuit applications by the short circuit and shoot through conditions.

Provided is a circuit in a gate driver circuit controlling a half bridge stage having high and low switches, the gate driver circuit having a high side driving circuit for driving the high switch and low side driving circuit for driving the low switch, the circuit ensuring turning OFF of the high side driving circuit and the high switch. The circuit includes an input portion for receiving input signals for the high and low side driving circuits and a shutdown signal; and an output portion for providing SET and RESET signals to the high and low side driving circuits, wherein the high side driving circuit is turned OFF when the input signal for the high side driving circuit is inactive and when the input signal for the low side driving circuit becomes active.

Other features and advantages of the present invention will become apparent from the following description of the invention that refers to the accompanying drawings.

### BRIEF DESCRIPTION OF THE DRAWINGS

FIG. 1 is a diagram of a gate driver circuit including the reset circuit of the present invention and a half bridge stage; and

FIG. 2 is a diagram of a circuit of the present invention; and

FIG. 3 is time diagram of signals provided by the circuit of FIG. 1.

### DETAILED DESCRIPTION OF EMBODIMENTS OF THE INVENTION

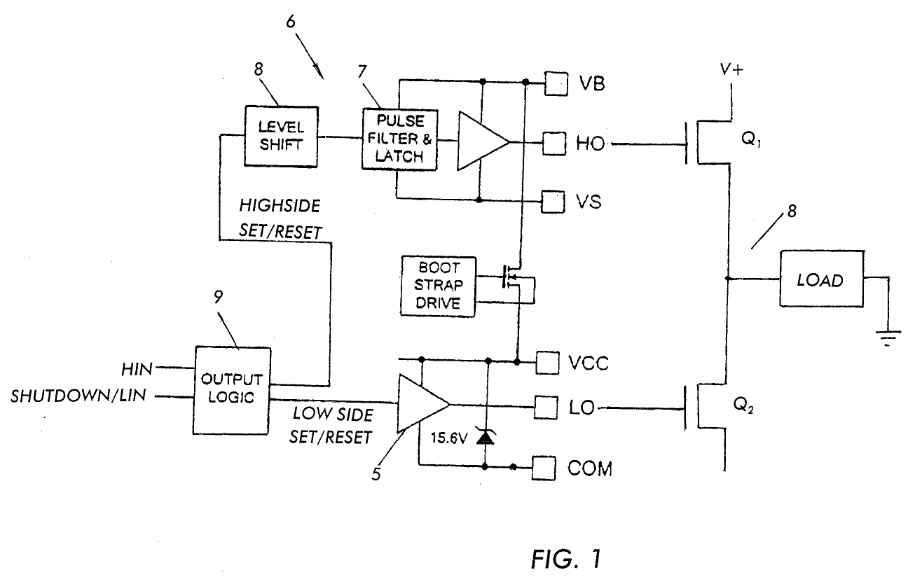

As shown in FIG. 1, the present invention ensures a safer operation of the applications that include the gate driver circuit 6 driving a half-bridge 8 having high and low switches Q1 and Q2. This is achieved by providing a circuit 9 that provides a redundant output signal RESET, which is sent to the high side driving circuit 7 of the gate driver circuit each time either the Shutdown or an input signal LIN to the low side driving circuit 5 become active, even if the input signal HIN to the high side driving circuit 7 is inactive. The redundant RESET signal turns OFF the high side driving circuit 7 and its corresponding switch Q1, unless the high side driving circuit 7 and its corresponding switch Q1 are already turned OFF.

As illustrated, the gate driver circuit 6 may optionally include pulse filter and latch and boot drive circuits as well as VB, VS, VCC, and common voltage sources. Signals for driving the high and low switches Q1 and Q2 are provided at the high and low output terminals HO and LO.

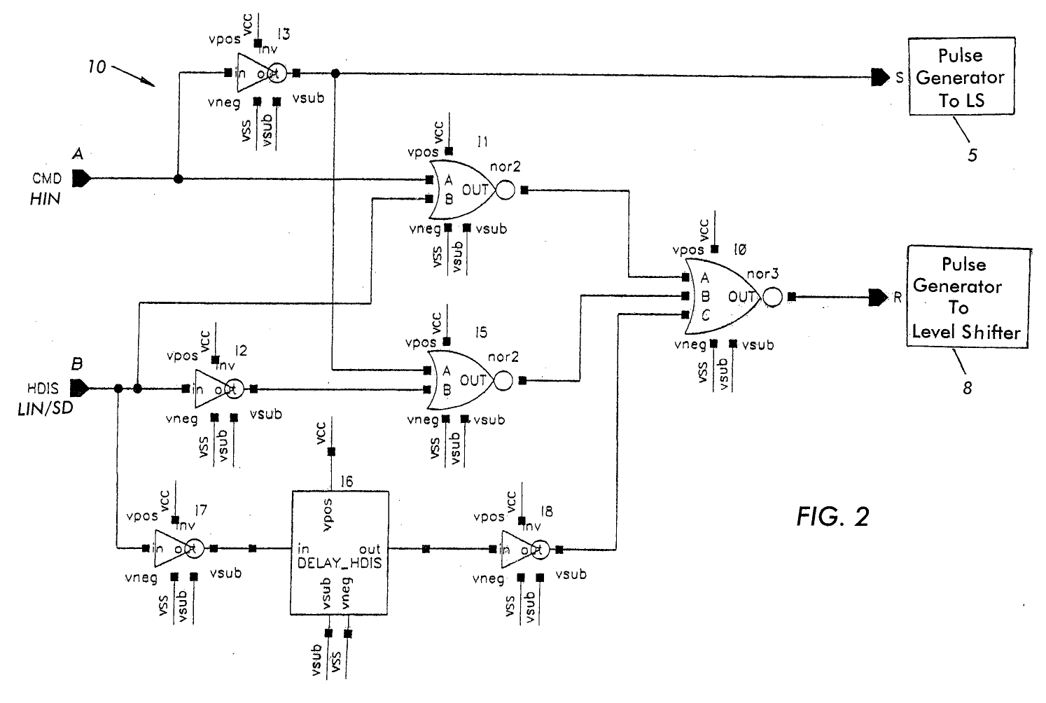

FIG. 2 illustrates the internal logic of the circuit 9 that is enabled in the gate driver circuit 6. As shown, the circuit 9 receives the input signals for the high and low side driving circuits 7 and 5 at input terminals A and B respectively. Additionally, a shutdown signal is received at the input terminal B. In response to the input signals, the circuit 9 generates SET and RESET signals that are used to assure turning OFF of the high side driving circuit 7 of the gate driver circuit and its corresponding switch Q1 (see FIG. 1).

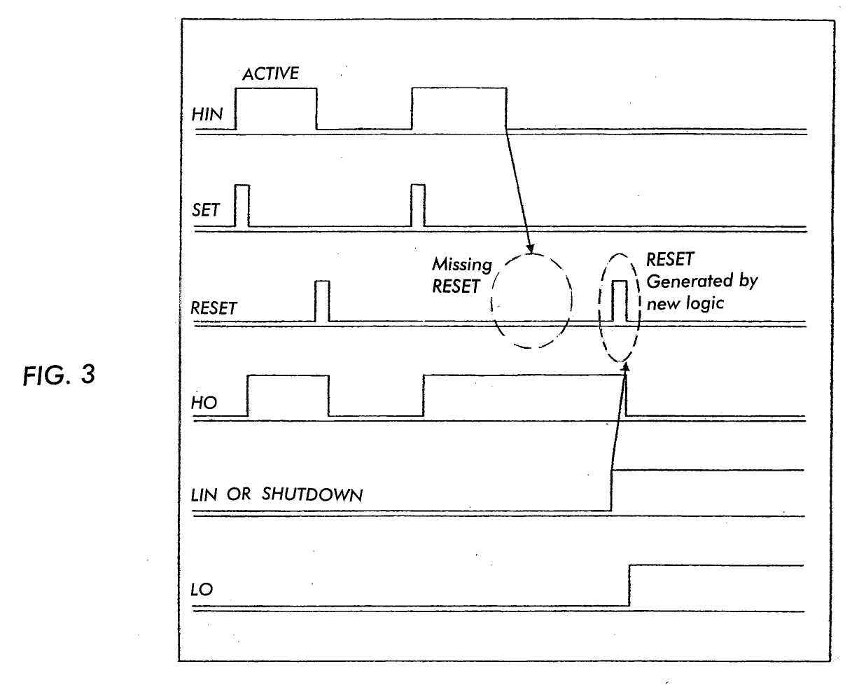

As illustrated in FIG. 3, the SET signal is sent to the low side driving circuit 5 (FIGS. 1 and 2) every time the input terminal A is enabled. This enabling or activating of the input terminal A is triggered by an edge of the input signal HIN for the high side driving circuit 7.

The RESET signal is sent to a level shift circuit 8 of the high side driving circuit 7 (FIG. 1) every time the input terminal A is disabled or inactivated. This operation is also triggered by the edge of the input signal for the high side driving circuit 7.

The RESET signal is also sent to the level shift circuit 8 of the high side driving circuit 7 every time the input terminal B is enabled or becomes active. This activation is triggered by an edge of the input signal LIN to the low side driving circuit or the shutdown signal.

With reference back to FIG. 2, the circuit 9 includes inverter circuits 12, 13, 17, and 18, NOR circuits 10, 11, and 15, and a delay circuit 16.

When the input signal HIN is received at the input terminal A, it is provided to the NOR circuit 11. The inverse of the input signal HIN at the input terminal A, generated by the inverter circuit 13 is provided to the NOR circuit 15 and, as stated above, as the SET signal to the low side driving circuit 5.

The NOR circuit 11 also accepts the input signal LIN from the input terminal B and supplies a first input to the NOR circuit 10. The NOR circuit 15 receives an inverse of the input signal LIN from the input terminal B, generated by the inverter circuit 12 and supplies a second input to the NOR circuit 10. The delay circuit 16 receives the inverse of the input signal LIN from the input terminal B, generated by the inverter circuit 17 and provides its signal, inverted by the inverter circuit 18, as the third input to the NOR circuit 10. The output of the NOR circuit 10 is the RESET signal described above.

FIG. 3 shows a timing diagram example where a RESET pulse is erroneously not generated when HIN goes inactive, for example, due to noise. When LIN or SHUTDOWN goes active, the redundant RESET pulse is generated, protecting the output switches.

Although the present invention has been described in relation to particular embodiments thereof, many other variations and modifications and other uses will become apparent to those skilled in the art. It is preferred, therefore, that the present invention not be limited by the specific disclosure herein.

What is claimed is:

1. A circuit in a gate driver circuit controlling a half bridge stage having high and low switches, the gate driver circuit having a high side driving circuit for driving the high switch and low side driving circuit for driving the low switch, the circuit ensuring turning OFF of the high side driving circuit and the high switch, the circuit comprising:
an input portion for receiving input signals for the high and low side driving circuits and a shutdown signal; and
an output portion for providing SET and RESET signals to the high and low side driving circuits,
wherein the high side driving circuit is turned OFF when the input signal for the high side driving circuit is inactive and when the input signal for the low side driving circuit becomes active.

2. The circuit of claim 1, wherein the RESET signal is a redundant output signal that is sent each time either the shutdown or the input signal to the low side driving circuit is enabled.

3. The circuit of claim 1, wherein the RESET signal is sent when the input signal to the high side driving circuit is disabled.

4. The circuit of claim 3, wherein sending of the SET and RESET signals is triggered by an edge of the input signal for the high side driving circuit.

5. The circuit of claim 3, wherein the RESET signal is sent every time the input signal to the low side driving circuit is enabled.

6. The circuit of claim 7, wherein sending of the RESET signal is triggered by an edge of the input signal for the low side driving circuit and the shutdown input signals.

7. The circuit of claim 1, further comprising:
a first inverter circuit for receiving and inverting the input signal for the high side driving circuit, the first inverter providing the inverse of input signal for the high side driving circuit as the SET signal;
second and third inverter circuits for receiving and inverting the input signal for the low side driving circuit and the shutdown input signal;
a first NOR circuit for receiving the input signals for the high and low side driving circuits;
a second NOR circuit for receiving the inverse of the input signals for the high and low side driving circuits from the first and second inverters,
a delay circuit for receives the inverse of the input signal for the low side driving circuit from the inverter circuit;
a fourth inverter circuit for receiving and inverting an output signal from the delay circuit; and
a third NOR circuit for receiving outputs of the first, second, and third NOR circuits and providing an output that is the RESET signal.
